(19) United States
(12) Patent Application Publication
(10) Pub. No.: US 2023/0384142 A1
(43) Pub. Date: Nov. 30, 2023

(54) Sensing And Control For A Multiphase Measurement System With Separator

(71) Applicant: NeoTek Energy, Inc., Plano, TX (US)

(72) Inventors: David H. Reasoner, Dallas, TX (US); Douglas B. Weiner, Plano, TX (US); Richard C. Eden, Briarcliff, TX (US); Ronald E. McDaniel, Fort Worth, TX (US)

(21) Appl. No.: 18/326,393

(22) Filed: May 31, 2023

Related U.S. Application Data
(60) Provisional application No. 63/347,398, filed on May 31, 2022.
(60) Provisional application No. 63/347,421, filed on May 31, 2022.

(51) Int. Cl. G01F 23/14; B01D 19/00

(52) U.S. Cl. CPC G01F 23/14; B01D 19/0063

(57) ABSTRACT

A separator and measurement system includes a separator arranged to separate gas from liquid. The separator has a gas collection pipe and a gas outlet pipe positioned at a top of the separator to extend downward through the gas collection pipe and a gas line assembly connected to a gas outlet of the gas outlet pipe to receive gas. Differential pressure sensors can be positioned to measure liquid level within the separator.

### CROSS -REFERENCE TO RELATED PATENT APPLICATIONS

This application claims the priority benefit of U.S. Patent Application No. 63/347,398, filed May 31, 2022, and U.S. Patent Application No. 63/347,421, filed May 31, 2022, both of which are hereby incorporated by reference in their entirety.

### TECHNICAL FIELD

The present disclosure generally relates to improved differential pressure sensor systems and gas handling systems suitable for use in separator based measurement systems capable of continuous or near real time analysis of multi-phase fluids that contain oil, gas, and water.

### BACKGROUND

Wellbore fluids from oil or gas wells drilled into conventional petroleum reservoirs are often multi-phase fluids that contain oil, gas and water. The amount and mixture of these components can vary over time making wellbore fluid difficult to characterize and identify. The properties, such as composition, flow rate, and viscosity of each component (oil, water, and gas), can vary from even closely spaced wells. Additionally, quantities of each phase vary with time, with the oil and gas fractions typically reducing with respect to the water fraction. Monitoring provides key insights to the wells ongoing operation and performance.

Flow rates of the components of a multi-phase flow can be measured with a test separator. Since a conventional test separator can be expensive and bulky, it is often not practical to have a test separator continuously measuring production on every well. Instead, a small number of test separators (1-5) are used per oil field, with each well being routed through the test separator at regular intervals. When a well is routed through a test separator, the conditions for the well change, which can distort production and multi-phase fluid conditions enough that the measurement does not represent the well conditions correctly. A test separator can also slow because of the long separation time for oil and water. The settling time can be particularly long in wet gas applications with small liquid fractions that require a long time to fill up the separator.

Even with a test separator, measuring properties of these components can be a slow and complex process. For example, flow rate of a multi-phase fluid is difficult to measure because flow rate of the gas can greatly differ from that of the oil. Variations in flow patterns can also affect measurements. Flow patterns can easily change in response to changes in liquid or gas distribution and the variations in physical properties of each multi-phase fluid component.

Measurement systems using cyclone separation techniques that are equipped with flow meters and other multi-phase sensor systems have been used for multi-phase wellbore fluid separation and monitoring. Flow through the oil and water outlets of conventional test separators are not continuous due to operation of dump valves. Flow must be stopped for a long period of time while fluids flow into the separator. When liquids reach a threshold the valves open and liquids flow rapidly through the outlets. This results in an averaging function with a sample rate that is typically about one sample every 60 minutes. Commonly, separators using cyclone separation techniques are equipped with flow meters and other multi-phase sensor systems for multi-phase wellbore fluid monitoring. Such a separator consists of a vertical pipe with a tangential inclined inlet and outlets for gas and liquid. Tangential flow from the inlet into the body of the cyclone separator causes the flow to swirl with sufficient velocity to produce centripetal forces on the entrained gas and liquids that push the liquid radially outward and downward toward a liquid exit, while the gas is driven inward and upward toward a gas exit. Unfortunately, cyclone separators are difficult to design and operate without having liquid carryover and/or gas carry under, which cause inaccuracies in the measurement equipment. In vertical tubing or risers of cyclone separators, buoyancy effects due to density differences between the gas and liquid cause the gas to rise much faster than the liquid, increasing slip between the gas and liquid. At low fluid velocities, wellbore liquids tend to accumulate at low pockets in horizontal pipes while gas coalesces into large and small bubbles, which propagate faster than the liquid, thereby increasing the slip between gas and liquid. These and other factors make providing real-time, high sample rate oil and water measurements difficult.

An additional problem is associated with measuring liquid level in cyclone or other separators. Commonly, a differential pressure sensor is used. In such sensor systems a pressure port at the bottom of the separator is provided. This bottom port has a higher pressure than the port at the top of the vessel due to the weight of the liquid in the separator. The measured differential pressure is proportional to liquid level in the separator. The differential pressure sensor must be located level with or below the port at the bottom of the vessel. A common problem with this measurement approach is that the tubing on the outside of the separator that connects to top port to the differential pressure sensor can fill with liquid as the two-phase fluid enters the separator vessel. This adds liquid weight on the low pressure side of the differential pressure sensor, causing significant errors in liquid level measurement.

What is needed is a low liquid retention time, two phase separator that permits liquid to flow continuously and can provide accurate liquid level sensing using differential pressure sensors. Ideally, accurate, real-time oil and water flow rates can be measured at minute or second time scales to permit real-time or near realtime adjustment of well operating conditions, over a wide range of input flow conditions. This near real-time measurement capability provides the ability to gain significant insights into well and reservoir operation. These can include but are not limited to slug detection and mitigation, choke control, as well as gas-lift optimization.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 illustrates flow through a separator and measurement system;

FIGS. 2(i), 2(ii), and 2(iii) illustrate respective front, back and side views of a separator and measurement system.

FIG. 2(iv) is a detail illustrating positioning and components of a gas line assembly

for a separator and measurement system;

FIG. 2(v) is a detail illustrating positioning and components of a liquid line assembly for a separator and measurement system;

FIGS. 3(i), 3(ii) illustrate one embodiment of separator internal design around a gas outlet; and

FIGS. 3(iii), and 3(iv) illustrate various embodiment of a differential pressure system.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

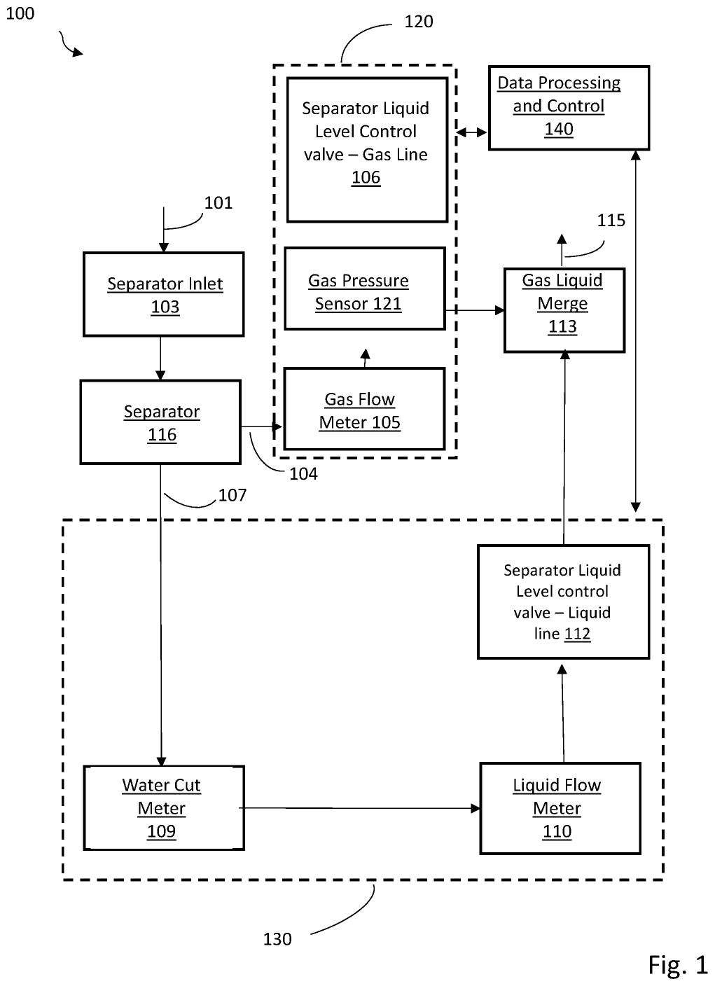

FIG. 1 illustrates flow through a low retention time separator and measurement system 100 suitable for wellbore fluid analysis. In this embodiment, multi-phase fluids can flow from a well into system inlet 101. The multi-phase fluids can pass into a separator inlet 103 to a two phase gas-liquid separator 116. Gas flows from the separator gas outlet 104 into a gas line assembly 120. In the gas line assembly 120, gas flows through one or more gas flow meters and sensors such as a gas flow meter 105 and an absolute gas pressure sensor 221. The gas then flows through the separator liquid level control valve-gas line 106. Ultimately, gas merges with liquid in the gas-liquid merge 113 before leaving the separator and measurement system 100.

After passing through the separator 116 and being separated from gas, liquid flows from a separator liquid outlet 107 into a liquid line assembly 130. Liquid flows through a liquid flow meters and sensors such as a water cut meter 109, continues through a liquid flow meter 110 and then passes through a separator liquid level control valve-liquid line 112 and merges with gas in a gas-liquid merge 113. The merged gas and liquid flow through the pipe assembly for flow conditioning, and then to system outlet 115.

During operation of system 100, sensor measurements including liquid and/or gas flow, as well as water cut meter 109 are taken at minute or less intervals. In some embodiments, measurements are taken at 10 second intervals. The system 100 is connected to a data processing and control system 140 that can be local, connected via wired or wireless connections to a remote data processing center, or have both local and remote data analysis and system 100 control capabilities. In some embodiments, machine learning algorithms supported by data processing and control system 140 can be utilized in a liquid level control algorithm to recognize periodic slugs of liquid and/or gas and manage the liquid level in anticipation of changes in fluid flow rate and/or changes in gas volume fraction. This will increase the maximum average fluid flow rates that can be handled by a separator vessel of a given size.

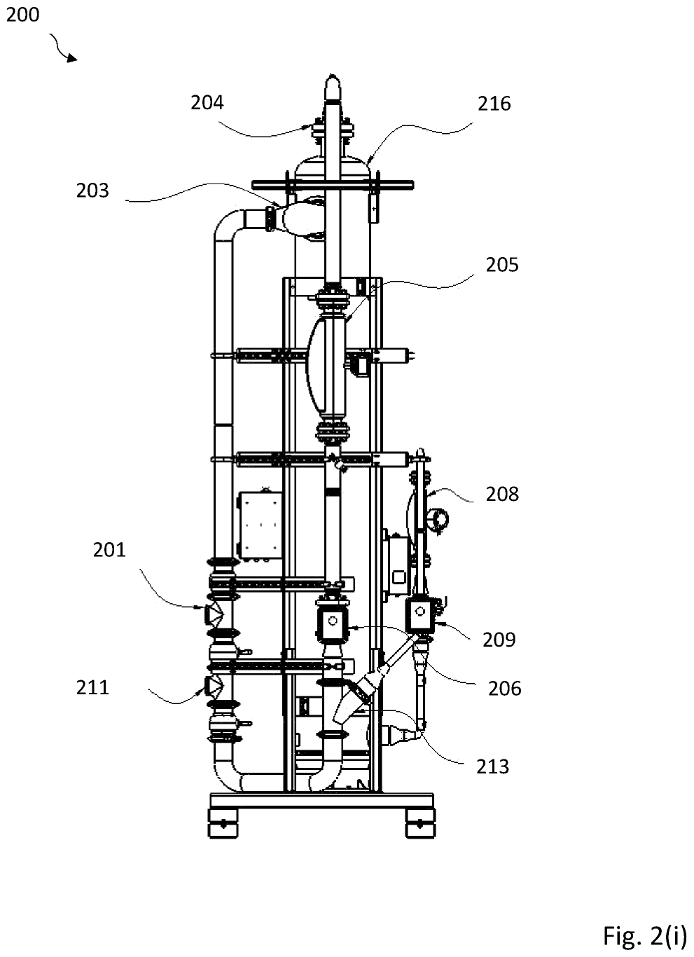

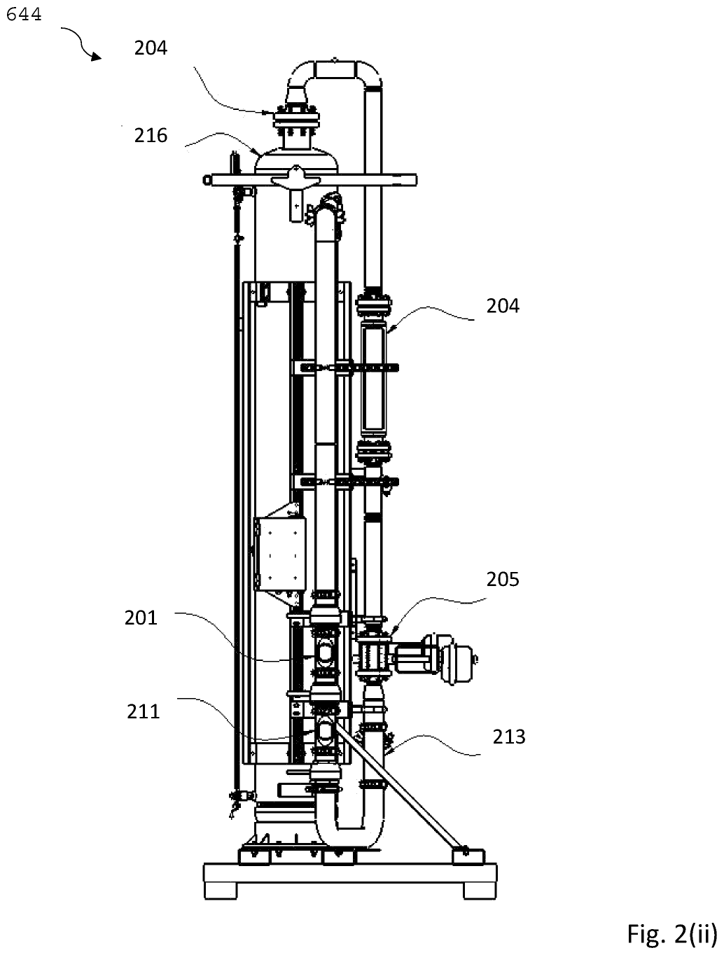

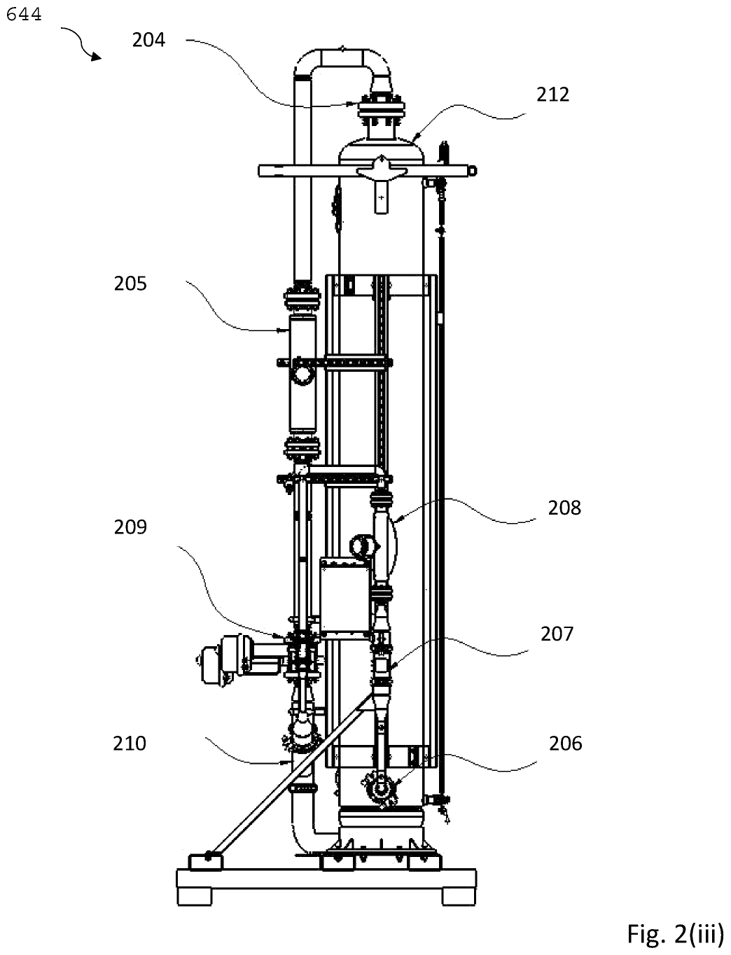

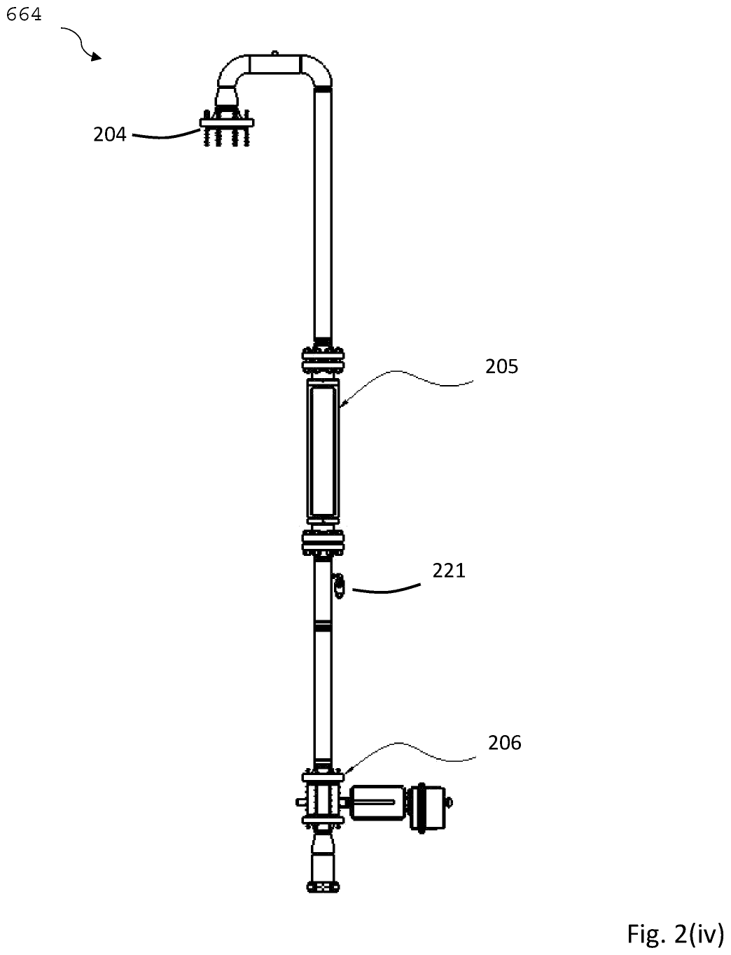

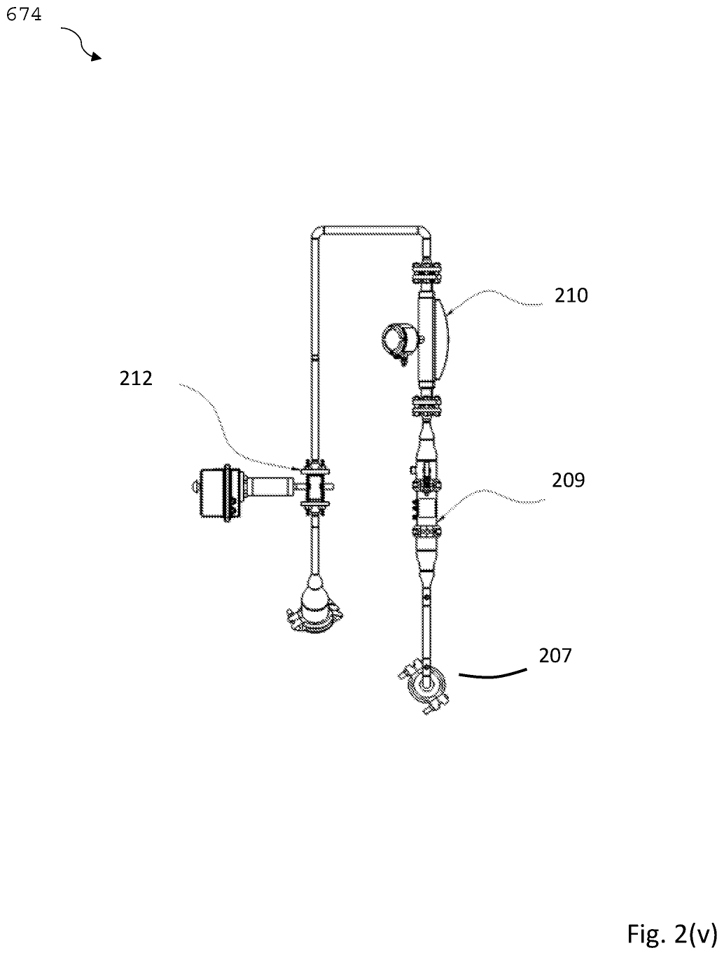

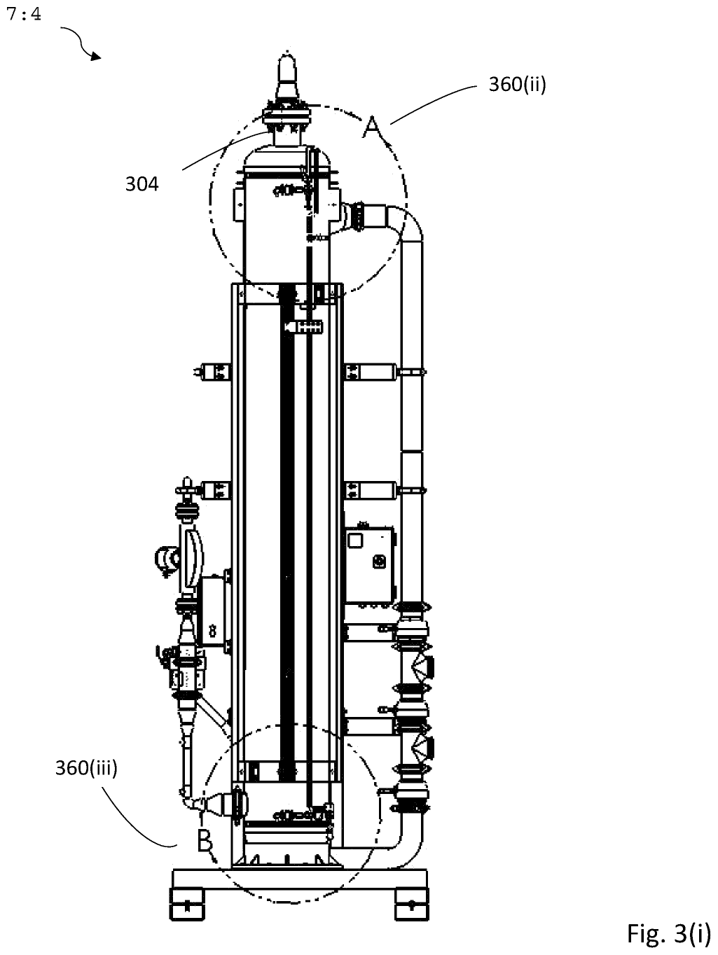

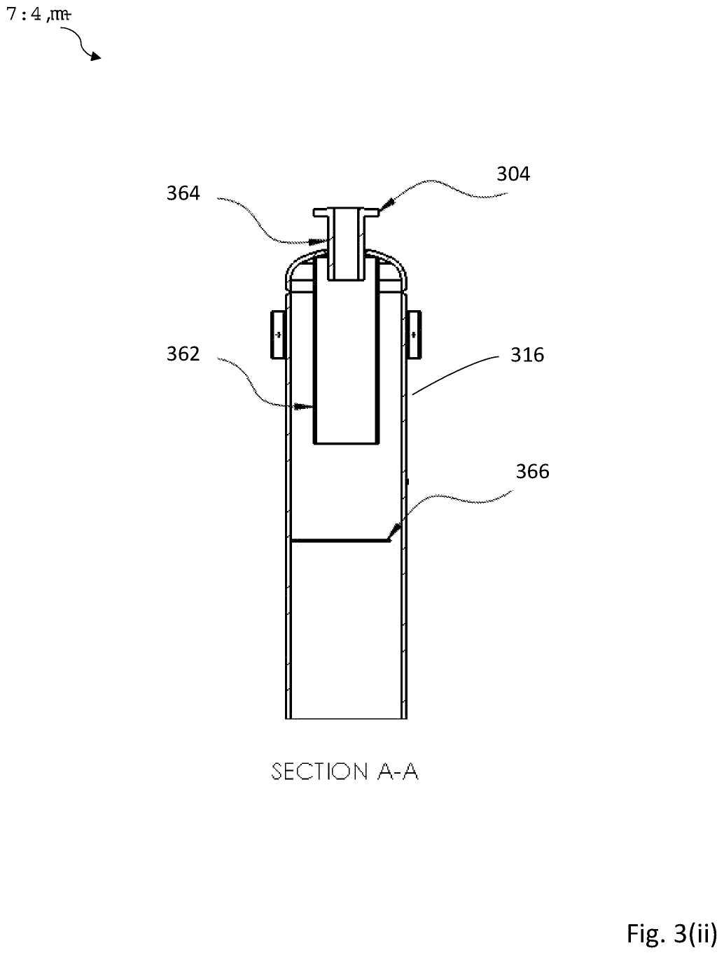

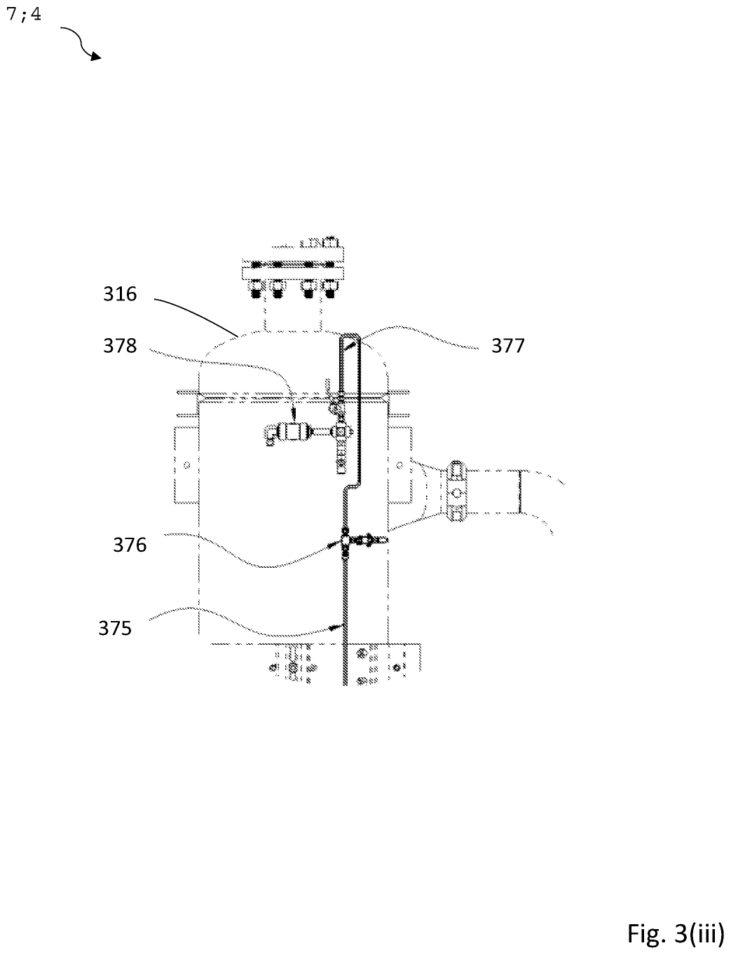

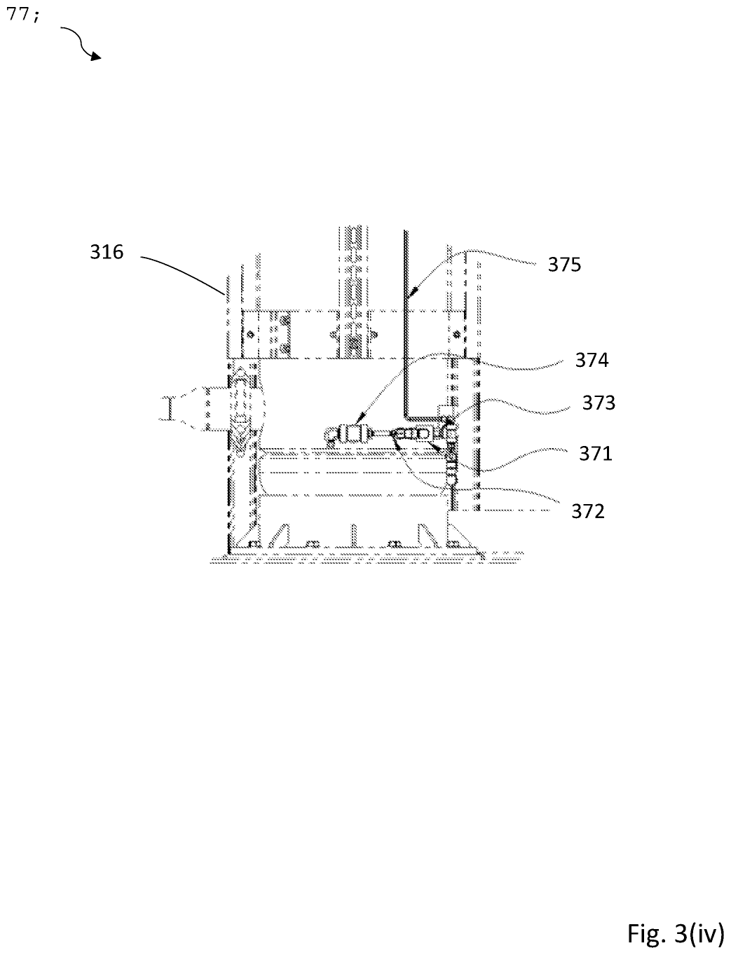

FIGS. 2(i), 2(ii), and 2(iii) illustrate respective front, back and side views of a separator and measurement system 200 that implements one embodiment of a system such as discussed with respect to FIG. 1. Detailed views of selected components of separator and measurement system 200 are illustrated in FIGS. 2(iv) and 2(v). Detailed and cross sectional views corresponding to one embodiment of the separator gas outlet 104 of FIG. 1 are illustrated in FIGS. 3(i), 3(ii). Detailed views corresponding to one embodiment of the separator liquid level measurement system are illustrated in FIGS. 3(iii), and 3(iv).

Fluid flow through system separator and measurement system 200 can begin with inlet 201. The multi-phase fluids can pass through a separator inlet 203 into a two phase gas-liquid separator 216. In one embodiment, the separator inlet 203 is positioned near a top of the separator 216. More specifically, the separator inlet 203 is positioned in a top half, top third, or top 15% of separator height, typically within 50 centimeters of the top. This location allows maximization of fluid handling capability of the separator 216 and permits relatively small separators to be used for handling a defined liquid capacity (as compared to separators with inlets positioned lower or in a bottom half of the separator).

After passing into the separator 216, gas flows from the separator gas outlet 204 into a gas line assembly 220 as seen in FIG. 2(iv). In the gas line assembly 220, gas flows through one or more gas flow meters and sensors such as a gas flow meter 205 and an absolute gas pressure sensor 221. The gas then flows through the separator liquid level control valve-gas line 206. Ultimately, gas merges with liquid in the gas-liquid merge 213 (seen in FIG. 2(ii)) before leaving the separator and measurement system 200.

After passing through the separator 216 and being separated from gas, liquid flows from a separator liquid outlet 207 into a liquid line assembly 230 as seen in FIG. 2(v). Liquid flows through a liquid flow meters and sensors such as a water cut meter 209, continues through a liquid flow meter 210 and then passes through a separator liquid level control valve-liquid line 212. Liquid merges with gas in the gas-liquid merge 213 (seen in FIG. 2(i)) before leaving the separator and measurement system 200. The merged gas and liquid flow through the pipe assembly for flow conditioning, and then to system outlet 215.

During operation of system 200, sensor measurements including liquid and/or gas flow, as well as water cut meter 209 are taken at minute or less intervals. In some embodiments, measurements are taken at 10 second intervals. The system 200 is connected to a data processing and control system (not shown) that can be local, connected via wired or wireless connections to a remote data processing center, or have both local and remote data analysis and system control capabilities (such as discussed with respect to data processing and control system 140 of FIG. 1). In some embodiments, machine learning algorithms supported by data processing and control system can be utilized in a liquid level control algorithm to recognize periodic slugs of liquid and/or gas and manage the liquid level in anticipation of changes in fluid flow rate and/or changes in gas volume fraction. This will increase the maximum average fluid flow rates that can be handled by a separator vessel of a given size.

FIGS. 3(i), 3(ii), 3(iii), and 3(iv) illustrate various embodiment of separator 216 internal design, sensor positioning, and control systems. FIG. 3(i) shows a sub-system 360 having a separator 316 with inlet 304 and further indicates positioning of cross section A-A (FIG. 3(ii)) and detail view A (FIG. 3(iii)) and detail view B (FIG. 3(iv) with respect to sub-system 360.

As seen in FIG. 3(ii), subsystem 360(ii) has a gas outlet 304 that includes a large diameter gas collection pipe 362 that extends down into the separator 316 approximately 15% of the separator height. Gas flows up through the gas collection pipe 362 and then passes through a smaller diameter gas outlet pipe 364, then through the gas outlet 304. The gas outlet pipe 364 extends down into the gas collection pipe 362. A splash plate 366 is positioned in the separator 316 below the gas collection pipe 362. Typically, liquid level in the separator 316 is maintained below the splash plate 366. During operation, the splash plate 366 prevents cyclonic gas flow from re-entraining liquid droplets from the top of the liquid surface.

In operation, as gas travels through the gas collection pipe 362, liquid droplets can collect on the inside surface of the gas collection pipe 362. If the gas outlet pipe 364 did not extend into the gas collection pipe 362, these liquid droplets could travel up an inside surface of the gas collection pipe, then through the gas outlet pipe, then through the gas outlet, negatively affecting gas/liquid separation efficiency. With the gas outlet pipe 364 extending into the gas collection pipe 362, the liquid droplets traveling up the inside surface of gas collection pipe 362 are trapped at the top of the vessel in the space between the inside surface of the gas collection pipe and the outside surface of the gas outlet pipe. When these droplets combine and reach a critical mass the large droplets fall down through the gas collection pipe 362 and into the lower section of the separator 316.

In some embodiments, the gas collection pipe 362 is positioned below any multi-phase inlet location so that liquid droplets entrained in the multiphase flow will not be immediately carried up through the gas collection pipe 362 and through the gas outlet 364 and gas outlet 304. In effect, this positioning ensures that gas and liquid are sufficiently separated before reaching the bottom level of the gas collection pipe. In some embodiments, the gas collection pipe extends downwardly into the separator from the top of separator between 10% and 20% of separator height. In one embodiment, the gas collection pipe extends downwardly into the separator from the top of separator to less than 15% of separator height

FIG. 3(iii) and FIG. 3(iv) illustrate components of sensor and control elements positioned on or in top (FIG. 3(iii)) and bottom (FIG. 3(iv)) of the separator 316. Such sensor and control systems are needed for maintaining liquid level in an optimal range inside the separator and are critical for achieving gas-liquid separation when fluid flow rates and/or gas volume fraction is changing dynamically. Such systems can include a control algorithm that can operate using data processing and control system 140 of FIG. 1, a liquid level measurement capability, and electronically controlled flow control valves. Input to the control algorithm can include liquid level, position of the valve on gas line assembly 220 (as seen in FIG. 2(iv)), and position of the valve on liquid line assembly 230 as seen in FIG. 2(v). The algorithm adjusts the positions of valves as needed to maintain the liquid level in the required range of operation. This minimizes liquid overflow in the gas outlet and gas underflow in the liquid outlet.

In one embodiment, a differential pressure sensor system 370 (seen in FIG. 3(iii) and FIG. 3(iv)) is used to measure the liquid. Differential pressure sensor system 370 includes a differential pressure sensor 371 connected to a low pressure differential port 372 and a high pressure differential port 373. These can be respectively connected in fluid communication with separator port 374 (positioned at a bottom of the separator 316) and separator port 378 (positioned at a top of the separator 316). Tubing 375 filled with fluid connects the high pressure differential port 373 to the separator port 378.

In operation, one side of a differential pressure sensor 371 is connected at a top of the separator 316 while the other side is connected at a bottom of the separator 316. Fluid filled tubing 375 causes the separator port 378 to be at a higher pressure than the separator port 374 at the bottom of the separator, and differential pressure to be inversely proportional to the liquid level in the separator.

In some arrangements, temperature fluctuations across 24 hour periods and across seasons of the year can cause the fluid in the tubing 375 to expand and contract. When the fluid expands it flows out of the tubing into the separator vessel. After this the liquid weight on the high pressure side of the differential pressure sensor has changed, resulting in liquid level measurement errors. To prevent this, a valve 376 is added on the tubing 375 at or below the level of separator port 378 at the top of the separator. Another section of tubing 377 can also be provided that extends vertically upwards above the valve 376 and separator port 378, then is turned back downward to connect to the separator port 378. The tubing 375 is filled with liquid only to the level of the valve 376. Fluid flowing into the separator 316 cannot enter the tubing 375 due to the vertical section of tubing 377 above the port. Over temperature cycles, as the fluid in the tubing expands and contracts, overflow into the separator vessel is prevented. The weight of the fluid in the tubing 375 is constant. This approach has resulted in accurate liquid level measurements across a wide range of temperatures over extended periods of time.

As will be understood, various embodiments of previously described components can be used in addition or as a substitute. For example, system 200 can be optionally equipped with density meters that can include nuclear densitometers, vibrating vane densitometers, or Coriolis flow meters that support density measurement. Other suitable meters can include ultrasound or sonar meters that measure density by changes in sound transmission characteristics.

As another example, system 200 can be optionally equipped with a differential pressure meter that can include any type of flow meter that enables flow measurement using a differential pressure. For example, a flow obstruction or restriction can be used to create a differential pressure that is proportional to the square of the velocity of the gas flow in a pipe. This differential pressure across the obstruction, using a pair of pressure sensors, can be measured and converted into a volumetric flow rate. Alternatively or in addition, accelerational pressure drop meter, elbow flow meter, v-cone meter, or comparison of pressures between standard orifices and Venturi devices can be used to measure differential pressure.

As another example, a water cut meter can utilize Coriolis density measurements. In other embodiments, microwave measurements, including resonant microwave oscillator or microwave absorption device can be used.

As another example, a liquid flow meter can include devices which measure aspects and characteristics of flow, including density and viscosity. Coriolis meters including straight or bent tube meters, venturi meters vibratory meters, or other suitable systems can be used. Thermal, turbine, positive displacement, vortex, or ultrasonic meters can be also used.

As another example, system 200 can be optionally equipped with a water conductivity meter can include various electrical components, including electrode pairs or microwave components that allow calculation of conductivity.

As another example, system 200 can be optionally equipped with a chemical sensor can include sensors able to detect carbon dioxide, hydrogen sulfide, or pH. Sensors can be based on electrochemical, chemiresitive, amperometric, resistive, optical changes, or other suitable reactions.

In some embodiments, various other sensor systems can be used, including pressure, strain, or temperature sensors.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A separator and measurement system, comprising:
a separator arranged to separate gas from liquid, the separator having a gas collection pipe and a gas outlet pipe positioned at a top of the separator to extend downward through the gas collection pipe; and
a gas line assembly connected to a gas outlet of the gas outlet pipe to receive gas.

2. The separator and measurement system of claim 1, wherein gas collection pipe extends downwardly into the separator from the top of separator between 10% and 20% of separator height.

3. The separator and measurement system of claim 1, wherein a separator inlet is positioned in a top 15% of the separator.

4. The separator and measurement system of claim 1, wherein a splash plate is positioned in the separator below the collection pipe.

5. The separator and measurement system of claim 1, wherein sensors are positioned to measure conditions within the separator.

6. The separator and measurement system of claim 1, wherein differential pressure sensors are positioned to measure liquid level within the separator.

7. The separator and measurement system of claim 1, wherein gas flow and liquid flow measurements are taken in near realtime at minute or less intervals.

8. A separator and measurement system, comprising:
a separator arranged to separate gas from liquid and having a top and a bottom port;
a differential pressure sensor system to measure liquid level in the separator using a differential pressure sensor positioned at a bottom of the separator to connect to the bottom port, and also connected to a fluid filled tube connecting the differential pressure sensor to the top port.

9. The separator and measurement system of claim 8, wherein the fluid filled tube at least partially extends above the top port.

10. The separator and measurement system of claim 8, wherein differential pressure in the separator is inversely proportional to differential pressure sensor measurements.

11. The separator and measurement system of claim 8, wherein gas flow and liquid flow measurements are taken at minute or less intervals.
